(19) United States
(12) Patent Application Publication
(10) Pub. No.: US 2022/0281110 A1
(43) Pub. Date: Sep. 8, 2022

(54) INFORMATION PROCESSING DEVICE, INFORMATION PROCESSING METHOD, AND PROGRAM

(71) Applicant: SONY GROUP CORPORATION, TOKYO (JP)

(72) Inventor: KIRILL VANHEERDEN, TOKYO (JP)

(21) Appl. No.: 17/634,333

(22) PCT Filed: Aug. 11, 2020
(86) PCT No.: PCT/JP2020/030561

§ 371 Date: Feb. 10, 2022

(30) Foreign Application Priority Data
Aug. 22, 2019 (JP) 2019-151960

(51) Int. Cl. B25J 9/16

(52) U.S. Cl. CPC B25J 9/1666

(57) ABSTRACT

The present technology relates to an information processing device, an information processing method, and a program capable of generating a trajectory with smoother movement and/or shorter path based on the trajectories generated by a global trajectory planning.

The information processing device includes: a first processing unit that executes a collision avoidance optimization process of searching for a path that collides with an obstacle using N postures corresponding to input trajectories of a machine; and a second processing unit that sets a target value of each of the N postures to an intermediate position between two postures before and after a current posture and executes the collision avoidance optimization process. The present technology can be applied to, for example, control of a type of robot called a manipulator.

### TECHNICAL FIELD

The present technology relates to an information processing device, an information processing method, and a program, and particularly, to an information processing device, an information processing method, and a program capable of generating a trajectory with smoother movement and/or shorter path based on the trajectories generated by the global trajectory planning.

### BACKGROUND ART

As an algorithm for trajectory planning that moves a type of robot called a manipulator from the start position to the target position while avoiding obstacles, for example, a technique such as an RRT (Rapidly-exploring Random Tree) algorithm in which paths to a place that can be incrementally reached from the self-position are appropriately pruned and extended is known.

However, although the RRT algorithm can find the path to reach the target position at a high speed, since the optimality of the path is not taken into consideration, the path is unnecessarily long or the movement is not smooth.

Therefore, a method in which trajectories (paths) that can be reached from the start position to a target position is generated as a first step, and a trajectory with smoother movement and/or shorter path is generated based on trajectories obtained in the first step is generated in a second step may be considered. The first stage trajectory planning is also called the global trajectory planning, and the second stage trajectory planning is also called the local trajectory planning.

Various algorithms such as the BiRRT algorithm based on the above-mentioned RRT algorithm are known in the global trajectory planning. Various methods such as polynomial approximation spline interpolation, filtering, elastic band, and shortcut method are known in local trajectory planning. For example, a method using a polynomial approximation method is disclosed in PTLs 1 and 2.

### CITATION LIST

### Patent Literature

### [PTL 1]

### JP 2006-099474 A

### [PTL 2]

### WO 2017/223061

### SUMMARY

### Technical Problem

However, the conventional local trajectory planning methods have advantages and disadvantages, and a new method is desired.

The present technology has been made in view of such a situation and enables a trajectory with smoother movement and/or shorter path to be generated based on the trajectories generated by the global trajectory planning.

### Solution to Problem

An information processing device according to an aspect of the present technology includes: a first processing unit that executes a collision avoidance optimization process of searching for a path that collides with an obstacle using N postures corresponding to input trajectories of a machine; and a second processing unit that sets a target value of each of the N postures to an intermediate position between two postures before and after a current posture and executes the collision avoidance optimization process.

An information processing method according to an aspect of the present technology includes: allowing an information processing device to execute: executing a collision avoidance optimization process of searching for a path that collides with an obstacle using N postures corresponding to input trajectories of a machine; and setting a target value of each of the N postures to an intermediate position between two postures before and after a current posture and executing the collision avoidance optimization process.

A program according to an aspect of the present technology causes a computer to execute: a first process of executing a collision avoidance optimization process of searching for a path that collides with an obstacle using N postures corresponding to input trajectories of a machine; and a second process of setting a target value of each of the N postures to an intermediate position between two postures before and after a current posture and executing the collision avoidance optimization process.

In one aspect of the present technology, a collision avoidance optimization process for searching for a path that does not collide with an obstacle is executed using N postures corresponding to the input trajectories of the machine. The target value of each of the N postures is set at an intermediate position between two postures before and after a current posture, and the collision avoidance optimization process is executed.

The program can be provided by being transmitted via a transmission medium or by being recorded on a recording medium.

The information processing device may be an independent device or an internal block constituting one device.

### BRIEF DESCRIPTION OF DRAWINGS

FIG. 1 is a block diagram showing a configuration example of an embodiment of an information processing device to which the present technology is applied.

FIG. 2 is a diagram showing the results of a global trajectory planning process.

FIG. 3 is a conceptual diagram of a global trajectory planning process and a local trajectory planning process.

FIG. 4 is a flowchart illustrating a local trajectory planning process by a local trajectory planning unit.

FIG. 5 is a diagram illustrating the flow of a local trajectory planning process.

FIG. 6 is a diagram illustrating a collision avoidance optimization process.

FIG. 7 is a diagram showing a simulation result imitating a smoothing process.

FIG. 8 is a diagram illustrating a collision avoidance optimization process to which an obstacle repulsion zone is applied.

FIG. 9 is a diagram showing an example of setting an obstacle repulsion zone.

FIG. 10 is a diagram illustrating the flow of a local trajectory planning process.

FIG. 11 is a diagram comparing this method with other local trajectory planning methods.

FIG. 12 is a block diagram showing a configuration example of an embodiment of a computer to which the present technology is applied.

### DESCRIPTION OF EMBODIMENTS

Modes for embodying the present technique (hereinafter referred to as “embodiments”) will be described below. The description will be made in the following order.

1. Configuration example of information processing device

2. Explanation of local trajectory planning process

3. Application of obstacle repulsion zone

4. Comparison with other local trajectory planning methods

5. Configuration example of computer

<1. Configuration Example of Information Processing Device>

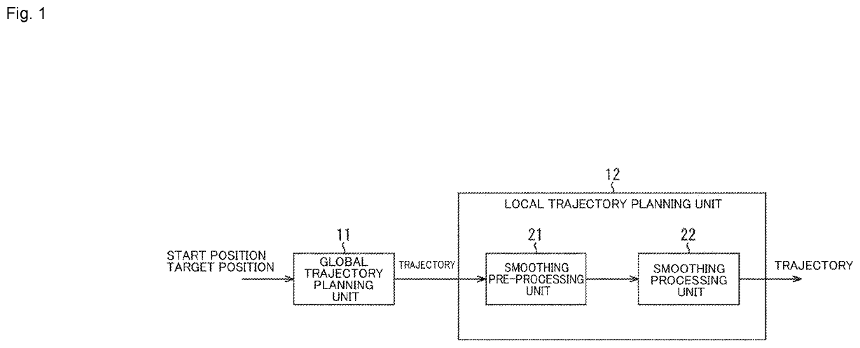

FIG. 1 is a block diagram showing a configuration example of an embodiment of an information processing device to which the present technology is applied.

An information processing device 1 in FIG. 1 is a device that calculates an optimum trajectory of a type of robot (machine) called a manipulator.

The information processing device 1 includes a global trajectory planning unit 11 and a local trajectory planning unit 12. The local trajectory planning unit 12 includes a smoothing pre-processing unit 21 as a first processing unit and a smoothing processing unit 22 as a second processing unit.

The start position of the manipulator and the target position of movement are input to the information processing device 1 and supplied to the global trajectory planning unit 11.

As the first process, the global trajectory planning unit 11 executes a process (hereinafter, also referred to as a global trajectory planning process) of generating a trajectory (path) that can reach the target position from the start position. In the global trajectory planning process, efficient movement to the target position and smoothness of movement are not a problem, and it is only necessary to reach the target position, so an algorithm that can obtain the trajectory at a high speed is desirable. In the present embodiment, the details of the global trajectory planning process are not particularly mentioned, but any method can be appropriately adopted. For example, an RRT (Rapidly-exploring Random Tree) algorithm, a BiRRT algorithm, an FMT (Fast Marching Tree), or the like can be used.

As a result of the global trajectory planning process, the global trajectory planning unit 11 outputs N postures corresponding to the trajectories of the manipulator to the smoothing pre-processing unit 21 of the local trajectory planning unit 12.

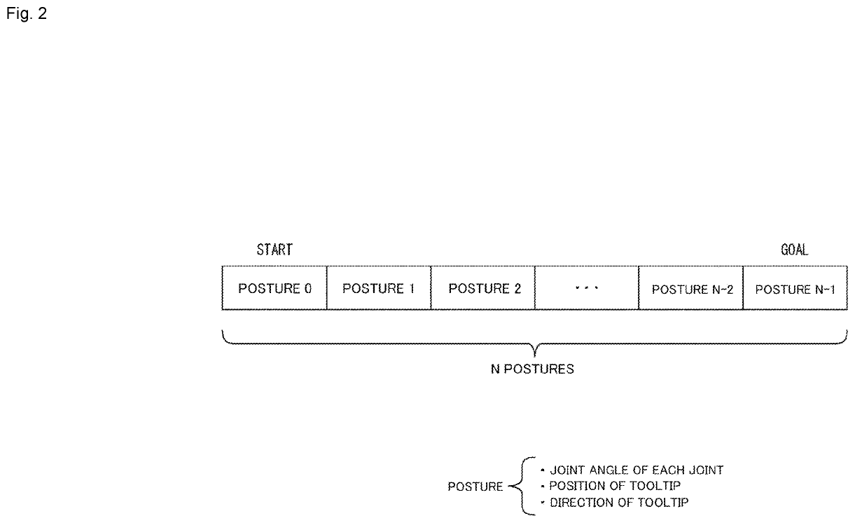

FIG. 2 shows the result of the global trajectory planning process supplied from the global trajectory planning unit 11 to the smoothing pre-processing unit 21.

The trajectory of the manipulator supplied from the global trajectory planning unit 11 to the smoothing pre-processing unit 21 is composed of N postures in time series, the posture 0 corresponds to the start position, and the posture N−1 corresponds to the target position. Therefore, the trajectory of the manipulator moves from the start position to the target position in the order of posture 0, posture 1, posture 2, . . . , posture N−2, and posture N−1. Each posture is composed of the joint angle of each joint, the position of the tooltip, and the direction of the tooltip.

The global trajectory planning unit 11 or the smoothing pre-processing unit 21 may downsample the trajectories consisting of N postures to a smaller number of postures than N and upsample to a larger number of postures than N, if necessary, depending on conditions such as operation processing time and operation accuracy.

Returning to FIG. 1, the local trajectory planning unit 12 executes a process (hereinafter, also referred to as a local trajectory planning process) of generating a trajectory with smoother movement and/or shorter path based on the trajectories calculated by the global trajectory planning unit 11.

The smoothing pre-processing unit 21 executes a collision avoidance optimization process of searching for a path that does not collide with an obstacle using the N postures supplied from the global trajectory planning unit 11 to the smoothing pre-processing unit 21 as pre-processing of the smoothing processing unit 22.

The smoothing processing unit 22 executes a collision avoidance optimization process of correcting each of the N postures calculated by the smoothing pre-processing unit 21 to a trajectory with smoother movement and/or shorter path. The smoothing processing unit 22 arranges the N postures corrected to trajectories with smoother movement and/or shorter path in time series, and outputs them as the optimum trajectories.

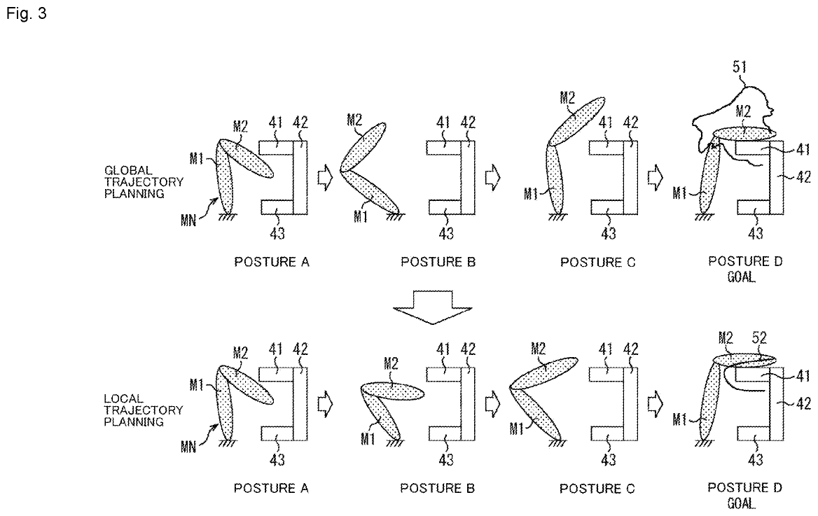

FIG. 3 is a conceptual diagram of the global trajectory planning process and the local trajectory planning process by the information processing device 1.

In the example of FIG. 3, the manipulator MN is composed of two members, a link M1 and a link M2. One end of the link M1 is fixed and the other end is connected to the link M2. The end of the link M2 on the side not connected to the link M1 is a tooltip.

The manipulator MN moves in the order of posture A, posture B, posture C, and posture D with the passage of time, and posture D is the target position (GOAL). There are one or more postures before posture A, between posture A and posture B, between posture B and posture C, and between posture C and posture D, but the illustration is omitted. Objects 41 to 43 are obstacles that the manipulator MN must avoid a collision when moving.

The trajectories of the posture A, the posture B, the posture C, and the posture D shown in the upper part of FIG. 3 show the trajectories obtained by the global trajectory planning process of the global trajectory planning unit 11.

In the global trajectory planning process by the global trajectory planning unit 11, efficient movement to the target position and smoothness of movement are not a problem, and a trajectory that reaches the target position is searched for. The trajectory 51 shown in the region of the posture D indicates the trajectory of the tooltip from the start position to the target position searched by the global trajectory planning process. As is clear from the figure, the trajectory 51 does not have a smooth movement and is not an efficient path.

The trajectories of the posture A, the posture B, the posture C, and the posture D shown in the lower part of FIG. 3 show the trajectories obtained by the local trajectory planning process of the local trajectory planning unit 12.

The trajectory 52 shown in the region of the posture D indicates the trajectory of the tooltip from the start position to the target position searched by the local trajectory planning process. The trajectory 52 has a smooth movement and is an efficient path as compared with the trajectory 51.

<2. Explanation of Local Trajectory Planning Process>

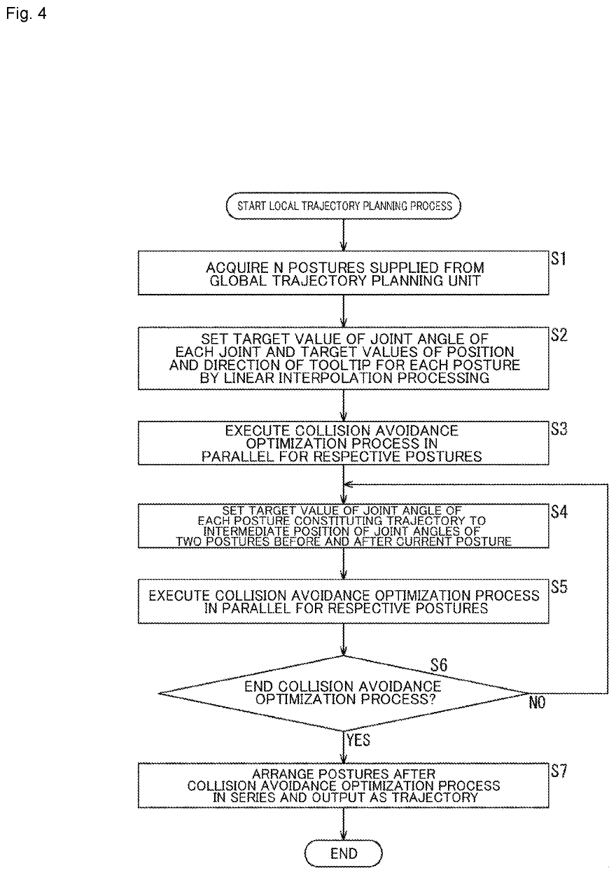

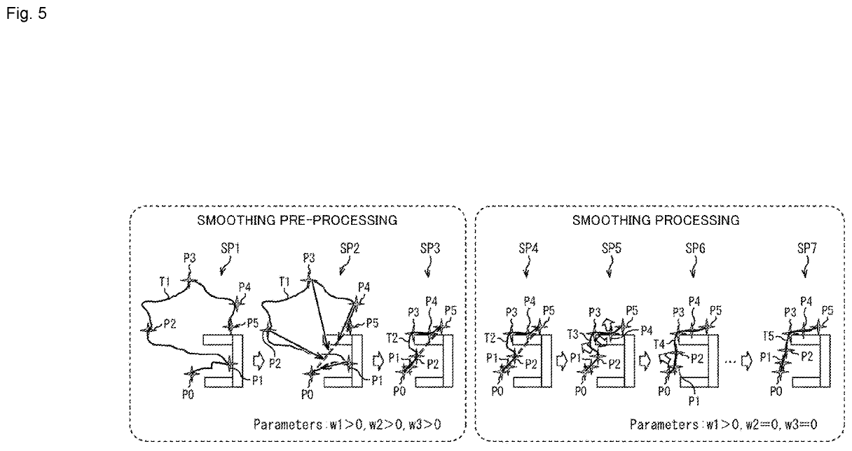

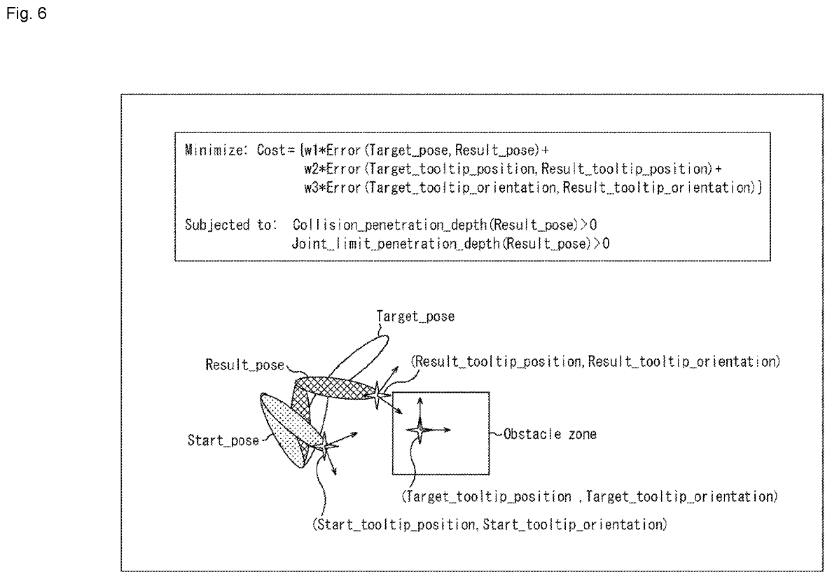

Next, the local trajectory planning process by the local trajectory planning unit 12 will be described in more detail with reference to the flowchart of FIG. 4. In the description of the flowchart, FIGS. 5 and 6 will be referred to as necessary.

The local trajectory planning process of FIG. 4 is started, for example, when the trajectories as a result of the global trajectory planning process are supplied from the global trajectory planning unit 11.

First, in step S1, the smoothing pre-processing unit 21 acquires N postures supplied from the global trajectory planning unit 11.

The state SP1 in FIG. 5 shows a state corresponding to the process of step S1.

The trajectory T1 of the state SP1 indicates a trajectory supplied from the global trajectory planning unit 11. The trajectory T1 is composed of N=6, that is, six postures of posture 0 to posture 5. The positions P0 to P5 indicate the positions of the tooltip of the manipulator MN in the postures 0 to 5, respectively.

In step S2, the smoothing pre-processing unit 21 sets the target value of the joint angle of each joint and the target value of the position and direction of the tooltip for each posture by linear interpolation processing.

The state SP2 in FIG. 5 shows a state corresponding to the process of step S2.

First, the posture 0 corresponding to the start position of the trajectory T1 and the posture 5 corresponding to the end position of the trajectory T1 are fixed. Then, the smoothing pre-processing unit 21 calculates the target values of the posture 1 (position P1) to the posture 4 (position P4) excluding the posture 0 (position P0) and the posture 5 (position P5) by linear interpolation between the posture 0 (position P0) and the posture 5 (position P5). As a result, the target values of the posture 1 (position P1) to the posture 4 (position P4) are set at the position on the straight line connecting the posture 0 (position P0) and the posture 5 (position P5) indicated by the broken line in the state SP2 of FIG. 5.

When the target value of the joint angle of each joint of each posture that is changed to the position on the straight line connecting the posture 0 of the start position and the posture 5 of the end position is represented by Target_pose[k], the target value of the tooltip position is represented by Target_tooltip_position[k], and the target value in the direction of the tooltip is expressed by Target_tooltip_orientation[k] (k=1, 2, . . . , N−2), the target value Target_pose[k] of the joint angle of each joint in each changed posture, the target value Target_tooltip_position[k] of the position of the tooltip, and the target value Target_tooltip_orientation[k] of the direction of the tooltip can be expressed by the following equations.

For k=1:N−2

Target_pose[k]=pose[0]+(k/(N−1))*(pose[N−1]−pose[0])

Target_tooltip_position[k]=tooltip_position[0]+(k/(N−1))*(tooltip_position[N−1]−tooltip_position[0])

Target_tooltip_orientation[k]=SLERP((k/(N−1)),tooltip_orientation[N−1],tooltip_orientation[0])

SLERP( ) in the equation of the target value Target_tooltip_orientation[k] of the direction of the tooltip represents a function of the SLERP method (spherical linear interpolation).

In step S3, the smoothing pre-processing unit 21 executes a collision avoidance optimization process of searching for a path that does not collide with an obstacle using the position of each of the four postures calculated by linear interpolation between the start position (posture 0) and the end position (posture 5) of the six postures as a target value. The smoothing pre-processing unit 21 executes the collision avoidance optimization process in parallel for the postures 1 and 4.

FIG. 6 is a diagram illustrating the collision avoidance optimization process executed in step S3.

The collision avoidance optimization process is a process of calculating a control value Result_pose of the joint angle of each joint of the manipulator MN and a control value Result_tooltip_position of the tooltip_position of the manipulator MN and a control value Result_tooltip_orientation of the orientation, the control values minimizing a cost function Cost represented by the weighted addition of errors with respect to the target value Target_pose of the joint angle of each joint of the manipulator MN and the target value Target_tooltip_position of the tooltip_position of the manipulator MN and the target value Target_tooltip_orientation of the orientation under the constraint that the manipulator MN does not collide with an obstacle and the angle limit of the joint angle of each joint is satisfied. The process of searching for a control value that minimizes the error between the target value and the control value of the manipulator MN under the constraint of not colliding with an obstacle is referred to as inverse kinematics for collision avoidance (CAIK: Collision aware inverse kinematics). Inverse kinematics for collision avoidance is known to be solved using various methods such as Roy Featherstone's Articulate body algorithm, nonlinear optimization, particle method, and null space Jacobian inverse kinematics.

Error(Target_pose, Result_pose), which is a part of the cost function Cost in FIG. 6, represents the error between the target value Target_pose and the control value Result_pose of the joint angle of each joint of the manipulator MN in a predetermined posture, and w1 is represents the weighting factor (tracking gain) for Error(Target_pose, Result_pose).

In addition, Error(Target_tooltip_position, Result_tooltip_position) represents the error between the target value Target_tooltip_position and the control value Result_tooltip_position of the tooltip_position of the manipulator MN in a predetermined posture, and w2 represents the weighting coefficient (tracking gain) for Error(Target_tooltip_position, Result_tooltip_position).

Error(Target_tooltip_orientation, Result_tooltip_orientation) represents the error between the target value Target_tooltip_orientation and the control value Result_tooltip_orientation of the tooltip direction of the manipulator MN in a predetermined posture, and w3 represents the weighting coefficient (tracking gain) for Error(Target_tooltip_orientation, Result_tooltip_orientation).

In addition, “Collision_pentration_depth(Result_pose)>0”, which is a part of the constraint, corresponds to the constraint that the manipulator MN does not collide with an obstacle, and is a function indicating the presence of a collision with an obstacle when the joint angle of each joint of the manipulator MN is the control value Result_pose.

“Joint_limit_pentration_depth(Result_pose)>0”, which is a part of the constraint, corresponds to the constraint that the joint angle of each joint of the manipulator MN satisfies the angle limit, and is a function indicating whether the angle limit is satisfied when the joint angle of each joint of the manipulator MN is the control value Result_pose.

In the collision avoidance optimization process in step S3, the weighting factor w1 for the joint angle of each joint of the manipulator MN, the weighting factor w2 for the position of the tooltip, and the weighting factor w3 for the direction of the tooltip are set to positive values other than zero (w1, w2, w3>0). The maximum allowable number of steps K in the collision avoidance optimization process is set to a predetermined constant KP1. This constant KP1 can be determined to an appropriate value according to the required level of search accuracy and calculation time.

The state SP3 in FIG. 5 shows the trajectory T2 after the collision avoidance optimization process in step S3.

The trajectory T2 is close to the position calculated by linear interpolation between the start position (posture 0) and the end position (posture 5) of the six postures, and is a trajectory avoiding obstacles. However, this trajectory T2 is not a trajectory with smooth movement and the shortest path. The trajectory T2 after the collision avoidance optimization process in step S3 is supplied to the smoothing processing unit 22.

In step S4, the smoothing processing unit 22 sets the target value of the joint angle of each posture constituting the trajectory to an intermediate position (average value) of the joint angles of the two postures before and after the target value. That is, the target value Target_pose[k] of the joint angle of each of the four joints excluding the start position (posture 0) and the end position (posture 5) is changed to the value obtained by the following equation.

Target_pose[k]=0.5*(pose[k−1]+pose[k+1]) For k=1:N−2

As will be described later, the processes of steps S4 to S6 are repeatedly executed until a predetermined condition is satisfied, but in the first process of step S4, the trajectory after the collision avoidance optimization process as the pre-processing supplied from the smoothing processing unit 22 by the process of step S3 is used.

In step S5, the smoothing processing unit 22 executes the collision avoidance optimization process in parallel for the four postures excluding the start position (posture 0) and the end position (posture 5) using the target values of each posture set in step S4.

In the collision avoidance optimization process in step S5, the weighting factor w1 for the joint angle of each joint of the manipulator MN is set to a positive value other than zero (w1>0), and the weighting factor w2 for the position of the tooltip and the weighting factor w3 for the direction of the tooltip are set to zero (w2, w3=0). That is, in the processing of the smoothing processing unit 22, parameters that minimize the cost function Cost are searched for by considering only the control value Result_pose of the joint angle of each joint. This is to prioritize the smoothness of the joint path because if the target value of the tooltip_position generated by interpolation is a position that collides with an obstacle, the smoothness is reduced and the joint path may not be smooth even if the path of the tooltip_position is smooth.

The maximum allowable number of steps K in the collision avoidance optimization process is set to a predetermined constant KP2. This constant KP2 can be appropriately determined according to the required level of search accuracy and calculation time, but since the processes of steps S4 to S6 are repeatedly executed, KP2=1 may be set in order to speed up the collision avoidance optimization process per time.

In step S6, the smoothing processing unit 22 determines whether the collision avoidance optimization process is to be ended. For example, the smoothing processing unit 22 may determine that the collision avoidance optimization process is to be ended when the number of repetitions of the collision avoidance optimization process reaches a predetermined number of times. Alternatively, the smoothing processing unit 22 may determine that the collision avoidance optimization process is to be ended when the difference between the processing result of the previous collision avoidance optimization process and the processing result of the current collision avoidance optimization process, specifically, the difference between the control values Result_pose of the joint angle of each joint is within a predetermined range. Alternatively, it may be determined that the collision avoidance optimization process is to be ended when the calculation time of the iterative process of steps S4 to S6 reaches a predetermined time.

If it is determined in step S6 that the collision avoidance optimization process is not to be ended, the process returns to step S4, and the processes of steps S4 to S6 described above are repeated. That is, the target value of each of the N postures constituting the trajectory is set to the intermediate position between the two postures before and after the target value, and the collision avoidance optimization process is executed again. In the second and subsequent processes of step S4, the target value of each posture is set using the result of the collision avoidance optimization process executed immediately before, and in step S5, the collision avoidance optimization process is executed in parallel for the four postures excluding the start position (posture 0) and the end position (posture 5).

The states SP4 to SP7 in FIG. 5 show how the collision avoidance optimization process is repeatedly executed.

The trajectory T2 of the state SP4 is a trajectory supplied from the smoothing processing unit 22 to the smoothing processing unit 22. As the collision avoidance optimization process is repeatedly executed, and the trajectory is corrected to the trajectory T3 in the state SP5, the trajectory T4 in the state SP6, and the trajectory T5 in the state SP7, the trajectory is changed to one with smooth movement and a short path.

If it is determined in step S6 that the collision avoidance optimization process is to be ended, the process proceeds to step S7, and the smoothing processing unit 22 arranges the postures after the final collision avoidance optimization process in time series from the start position to the end position and outputs them as a trajectory.

In this way, the local trajectory planning process ends.

When only the smoothing process by the smoothing processing unit 22 is performed, that is, when only the collision avoidance optimization process in which the intermediate position of the adjacent previous and subsequent postures is set as the target value is repeated, the number of repetitions until reaching the optimum solution increases and it takes a considerable amount of time.

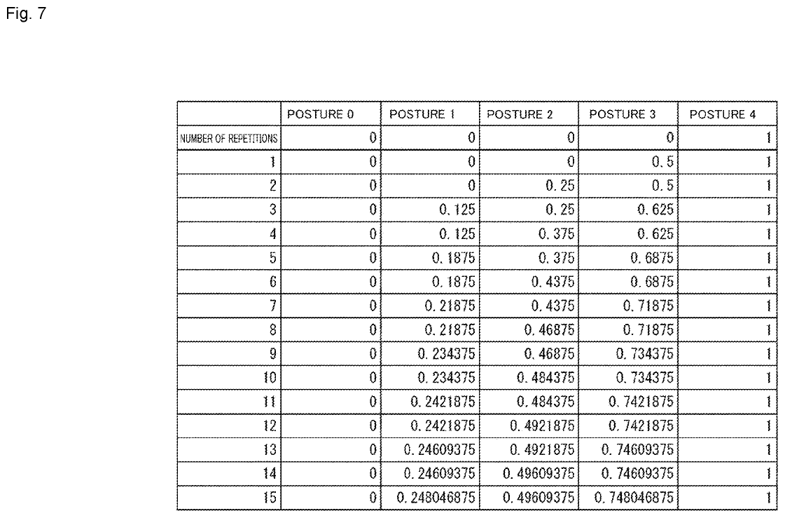

For example, as shown in FIG. 7, in the simulation process imitating the smoothing process by the smoothing processing unit 22, regarding the posture 0 at the start position as a value 0 and the posture 4 at the end position as a value 1, postures on a straight path connecting the start position and end position can be finally searched for, and a smooth and short path trajectory can be searched for, but it requires 15 iterations and processing time increases.

Therefore, by setting the trajectory using linear interpolation as the target value as the smoothing pre-processing, the number of repetitions can be reduced and the shortest path can be obtained at a high speed. That is, the smoothing pre-processing by the smoothing pre-processing unit 21 speeds up the search for the optimum path and improves the smoothness of the movement of the tooltip of the manipulator MN. However, if there is an obstacle, the trajectory using linear interpolation may collide with the obstacle, so at least one collision avoidance optimization process is required.

As described above, according to the local trajectory planning process of the information processing device 1, the trajectory can be quickly shortened by the linear interpolation process and the collision avoidance optimization process by the smoothing pre-processing unit 21. Then, by repeating the collision avoidance optimization process by the smoothing processing unit 22, the trajectory can be improved to a trajectory with smooth movement and a short path. In this way, it is possible to generate a trajectory with smoother movement and/or shorter path based on the trajectories generated by the global trajectory planning unit 11.

<3. Application of Obstacle Repulsion Zone>

When optimizing the trajectory, control may be added such that an obstacle repulsion zone is set for the joint angle of each joint of the manipulator MN so that each joint does not approach an obstacle in the obstacle repulsion zone as much as possible. In this case, a penalty function corresponding to the obstacle repulsion zone may be further added to the cost function Cost of the collision avoidance optimization process.

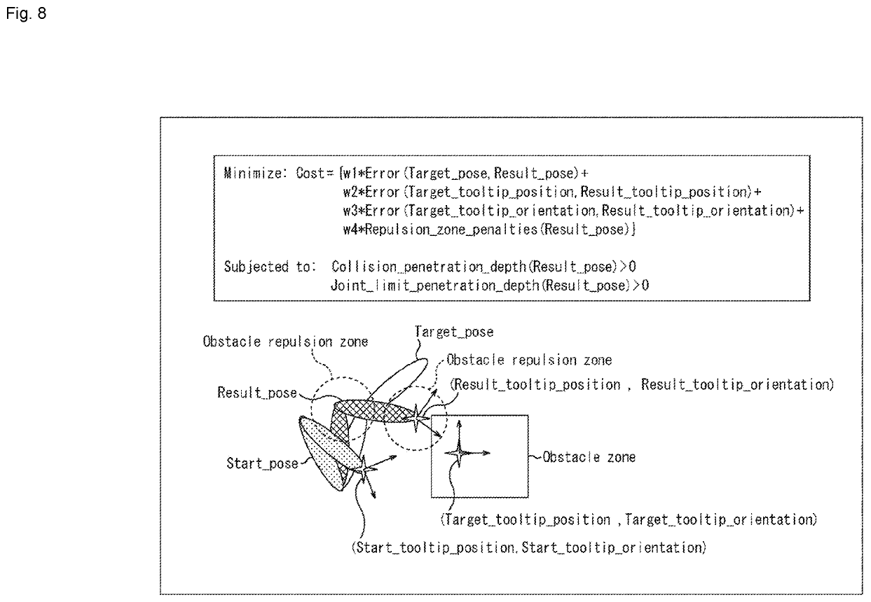

FIG. 8 is a diagram illustrating a collision avoidance optimization process when a penalty function corresponding to an obstacle repulsion zone is added.

In the cost function Cost in FIG. 8, a term w4*Repulsion_zone_penalties(Result_pose) obtained by multiplying a penalty function Repulsion_zone_penalties( ) by its weighting factor (tracking gain) w4 is added.

Therefore, the collision avoidance optimization process is a process calculating a control value Result_pose of the joint angle of each joint of the manipulator MN and a control value Result_tooltip_position of the tooltip_position of the manipulator MN and a control value Result_tooltip_orientation of the orientation, the control values minimizing a cost function Cost represented by the weighted addition of errors with respect to the target value Target_pose of the joint angle of each joint of the manipulator MN and the target value Target_tooltip_position of the tooltip_position of the manipulator MN and the target value Target_tooltip_orientation of the orientation and the penalty function Repulsion_zone_penalties(Result_pose) corresponding to the obstacle repulsion zone under the constraint that the manipulator MN does not collide with an obstacle and the angle limit of the joint angle of each joint is satisfied.

As shown in FIG. 8, the obstacle repulsion zone can be set as, for example, a circle having a radius r around the position of a joint, and a control value Result_pose of the joint angle of each joint is substituted into the penally function Repulsion_zone_penalties( ). The penalty function Repulsion_zone_penalties( ) can be, for example, a function such that the control value Result_pose has a larger value in a circle having a radius r as it is closer to the center of the circle.

The obstacle repulsion zone may be set in common for the N postures constituting the trajectory, or may be set individually.

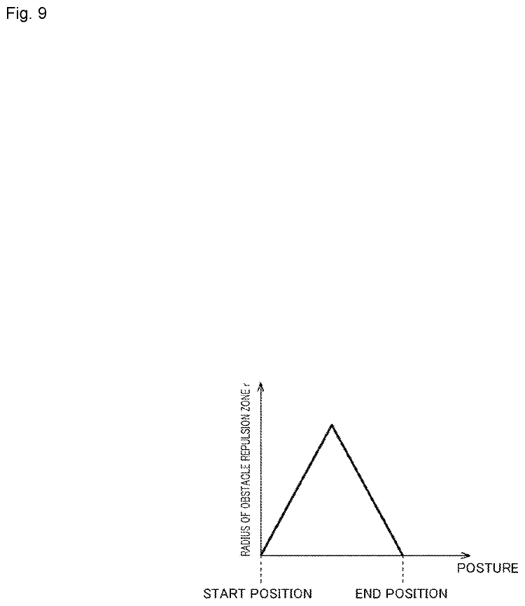

For example, as shown in FIG. 9, the obstacle repulsion zone can be set such that among the N postures constituting the trajectory, the closer the posture is to the start position or the end position, the smaller the radius r of the obstacle repulsion zone, and the radius r of the obstacle repulsion zone is the largest at intermediate posture between the start position and the end position. When the obstacle repulsion zone is set in this way, it is possible to prevent the manipulator MN from moving suddenly from the start position and the end position of the global plan generated by the global trajectory planning unit 11.

On the contrary, the obstacle repulsion zone may be set such that among the N postures constituting the trajectory, the closer the posture is to the start position or the end position, the larger the radius r of the obstacle repulsion zone, and the radius r of the obstacle repulsion zone is the smallest at the intermediate posture between the start position and the end position. The shape of the region forming the obstacle repulsion zone is not limited to a circle, but may be a polygon such as a rectangle or an octagon, or a three-dimensional shape such as a sphere or a cube.

In the local trajectory planning process of FIG. 4 when a penalty function corresponding to the obstacle repulsion zone is further added, the weighting factor w4 of the penalty function Repulsion_zone_penalties( ) of the collision avoidance optimization process in step S3 and the collision avoidance optimization process in step S5 is set to a positive value (w4>0) other than zero.

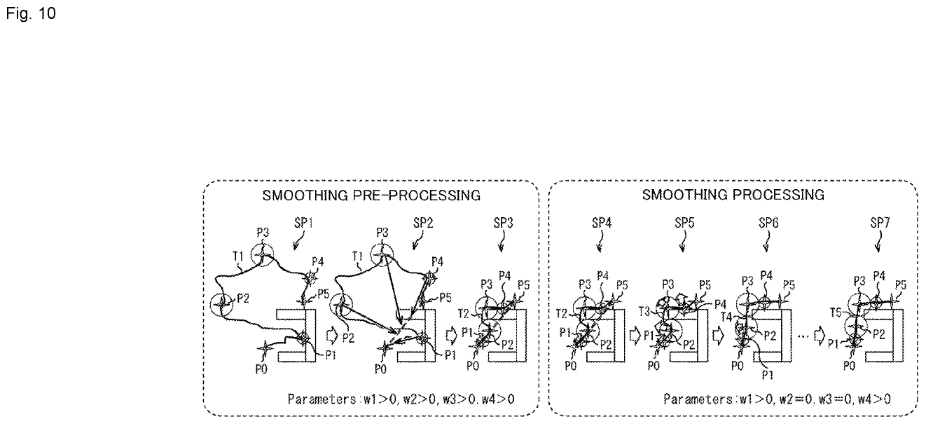

FIG. 10 is a diagram corresponding to the flow of the local trajectory planning process of FIG. 5 when the penalty function corresponding to the obstacle repulsion zone is applied to the cost function Cost and the local trajectory planning process of FIG. 4 is executed.

As shown in FIG. 10, when a penalty function corresponding to the obstacle repulsion zone is added to the cost function Cost of the collision avoidance optimization process, each joint of the manipulator MN is controlled to move away from the obstacle. However, on the other hand, the cost function Cost also tries to approach the target value, so that the joints converge at an equilibrium position. The equilibrium position depends on the weighting factors w1, w2, w3, and w4.

Even when a penalty function corresponding to the obstacle repulsion zone is added to the cost function Cost of collision avoidance optimization process, according to the local trajectory planning process, the trajectory can be shortened quickly by the linear interpolation processing and the collision avoidance optimization process by the smoothing pre-processing unit 21, and the trajectory can be improved to a trajectory with smooth movement and a short path by the iterative processing of the collision avoidance optimization process by the smoothing processing unit 22. In this way, it is possible to generate a trajectory with smoother movement and/or shorter path based on the trajectories generated by the global trajectory planning unit 11.

<4. Comparison with Other Local Trajectory Planning Methods>

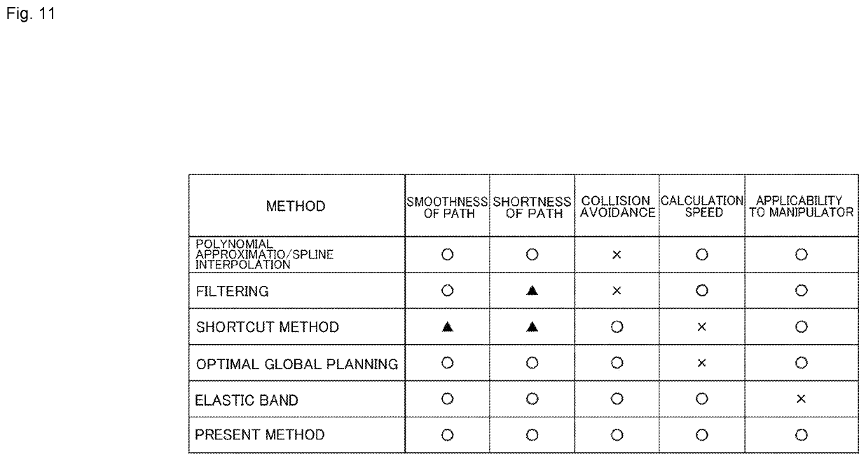

FIG. 11 is a table showing a comparison between the local trajectory planning process by the information processing device 1 (hereinafter referred to as the present method) and other local trajectory planning methods.

Other methods of local trajectory planning for comparison include, for example, polynomial approximation spline interpolation, filtering, shortcut, elastic band, and optimal global planning.

Polynomial approximation spline interpolation is a method of searching for a smooth path using polynomials. When a low-order polynomial is used in the polynomial approximation spline interpolation method, it cannot be guaranteed that a collision with an obstacle does not occur. On the other hand, when a high-order polynomial is used, it may be possible to avoid a collision with an obstacle, but the path is not smooth.

Filtering is similar to the approach of the polynomial approximation spline interpolation, and is a method of searching for a smooth path using a low-pass filter instead of a polynomial. Similar to the polynomial approximation spline interpolation method, this method cannot guarantee that collisions with obstacles do not occur at low-order filtering frequencies, and the path is not smooth at high-order filtering frequencies.

Elastic band is a technique designed for robot cars (moving vehicles) and act like rubber bands wrapped around colliding spheres. Although this technique can be applied only to the robot's tooltips, it does not consider manipulators with arms (links), so the arms can collide with obstacles and control that meets the kinematic constraint of the arms cannot be performed.

The shortcut method is a method of searching for a path by repeatedly trying the shortcut along the path. This method has a slow calculation speed and the shortcut function is limited. In the shortcut operation, since there is a possibility that two shortcuts conflict with each other, it is not possible to process a plurality of postures in parallel, so that the calculation time increases.

The optimal global planning method is a method for searching for an optimal path including a local trajectory planning in a global trajectory planning. This method does not require local trajectory planning, but has the problem that calculation time is long.

The present method can avoid collisions more reliably than the polynomial approximation spline interpolation method and the filtering method. Further, in the present method, since the paths of a plurality of postures constituting the trajectory can be obtained by parallel processing, the calculation time is fast. Furthermore, since the present method is a simple algorithm, it can be easily programmed into FPGA (field-programmable gate array) and is easy to implement. The present method can search for a smooth and short path in real time on a redundant or non-redundant robot manipulator while satisfying the constraint of collision and joint angle.

<5. Configuration Example of Computer>

The above-described series of processing can also be performed by hardware or software. When the series of processing is performed by software, a program including the software is installed in a computer. Here, the computer includes a computer which is embedded in dedicated hardware or, for example, a general-purpose personal computer capable of executing various functions by installing various programs.

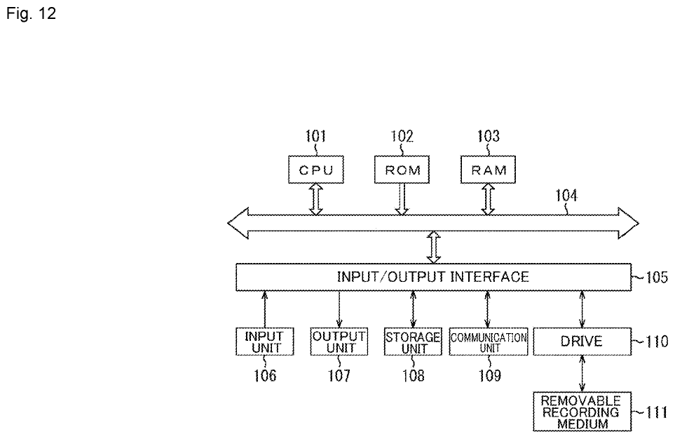

FIG. 12 is a block diagram illustrating an exemplary hardware configuration of a computer that performs the above-described series of processing in accordance with a program.

In the computer, a central processing unit (CPU) 101, a read-only memory (ROM) 102, and a random access memory (RAM) 103 are connected to each other by a bus 104.

An input/output interface 105 is further connected to the bus 104. An input unit 106, an output unit 107, a storage unit 108, a communication unit 109, and a drive 110 are connected to the input/output interface 105.

The input unit 106 is, for example, a keyboard, a mouse, a microphone, a touch panel, or an input terminal. The output unit 107 is, for example, a display, a speaker, or an output terminal. The storage unit 108 is, for example, a hard disk, a RAM disc, or a nonvolatile memory. The communication unit 109 is a network interface or the like. The drive 110 drives a removable recording medium 111 such as a magnetic disk, an optical disc, a magneto-optical disc, or a semiconductor memory.

In the computer that has the foregoing configuration, the CPU 101 performs the above-described series of processing, for example, by loading a program stored in the storage unit 108 on the RAM 103 via the input/output interface 105 and the bus 104 and executing the program. In the RAM 103, data or the like necessary for the CPU 101 to perform various kinds of processing is also appropriately stored.

The program executed by the computer (the CPU 101) can be recorded on, for example, the removable recording medium 111 serving as a package medium for supply. The program can be supplied via a wired or wireless transfer medium such as a local area network, the Internet, or digital satellite broadcasting.

In the computer, by mounting the removable recording medium 111 on the drive 110, it is possible to install the program in the storage unit 108 via the input/output interface 105. The program can be received by the communication unit 109 via a wired or wireless transfer medium to be installed in the storage unit 108. In addition, the program can be installed in advance in the ROM 102 or the storage unit 108.

It is noted that, in the present description, the steps having been described in the flowcharts may be carried out in parallel or with necessary timing, for example, when evoked, even if the steps are not executed in time series along the order having been described therein, as well as when the steps are executed in time series.

The embodiments of the present technology are not limited to the above-described embodiments, and various modifications can be made without departing from the gist of the present technology.

For example, a combination of all or part of the above-mentioned plurality of embodiments may be employed.

For example, the present technology can be configured as cloud computing in which one function is shared and processed in common by a plurality of devices via a network.

Further, the respective steps described in the above-described flowcharts can be executed by one device or in a shared manner by a plurality of devices.

Furthermore, in a case where a plurality of kinds of processing are included in a single step, the plurality of kinds of processing included in the single step may be executed by one device or by a plurality of devices in a shared manner.

The effects described in the present specification are merely examples and are not limited, and there may be effects other than those described in the present specification.

Note that the present technology can employ the following configurations.

(1) An information processing device including: a first processing unit that executes a collision avoidance optimization process of searching for a path that collides with an obstacle using N postures corresponding to input trajectories of a machine; and a second processing unit that sets a target value of each of the N postures to an intermediate position between two postures before and after a current posture and executes the collision avoidance optimization process.
(2) The information processing device according to (1), wherein the first processing unit executes the collision avoidance optimization process using positions of the N postures calculated by linear interpolation between a start position and an end position of each of the N postures corresponding to the input trajectories of the machine as target values.
(3) The information processing device according to (1) or (2), wherein the first processing unit and the second processing unit execute the collision avoidance optimization process in parallel for (N−2) postures excluding a start position and an end position.
(4) The information processing device according to any one of (1) to (3), wherein the posture is represented by a joint angle of each joint of the machine and a position and a direction of a tooltip of the machine, and the collision avoidance optimization process is a process of calculating the joint angle of each joint of the machine and the position and the direction of the tooltip of the machine, minimizing a cost function represented by a weighted addition of errors with respect to target values of the joint angle of each joint of the machine and the position and the direction of the tooltip of the machine under constraint that the machine does not collide with an obstacle and an angle limit of the joint angle of each joint is satisfied.
(5) The information processing device according to (4), wherein the collision avoidance optimization process is a process of calculating the joint angle of the machine and the position and the direction of the tooltip of the machine, minimizing the cost function represented by a weighted addition further with a penalty function corresponding to an obstacle repulsion zone.
(6) The information processing device according to (5), wherein the obstacle repulsion zone is set smaller as the posture is closer to the start position or the end position among the N postures.
(7) The information processing device according to any one of (4) to (6), wherein the first processing unit sets weighting factors for the joint angle of the machine and the position and the direction of the tooltip of the machine in the cost function to positive values other than zero and executes the collision avoidance optimization process.
(8) The information processing device according to any one of (4) to (7), wherein the second processing unit sets a weighting factor for the joint angle of the machine to a positive value other than zero, sets weighting factors for the position and direction of the tooltip of the machine in the cost function to zero, and executes the collision avoidance optimization process.
(9) The information processing device according to any one of (1) to (8), wherein the second processing unit repeatedly executes the collision avoidance optimization process a predetermined number of times, and stops the repetition of the collision avoidance optimization process when the number of repetitions reaches a predetermined number of times or when a difference from a previous processing result is within a predetermined range.
(10) An information processing method including: allowing an information processing device to execute: executing a collision avoidance optimization process of searching for a path that collides with an obstacle using N postures corresponding to input trajectories of a machine; and setting a target value of each of the N postures to an intermediate position between two postures before and after a current posture and executing the collision avoidance optimization process.
(11) A program for causing a computer to execute: a first process of executing a collision avoidance optimization process of searching for a path that collides with an obstacle using N postures corresponding to input trajectories of a machine; and a second process of setting a target value of each of the N postures to an intermediate position between two postures before and after a current posture and executing the collision avoidance optimization process.

### REFERENCE SIGNS LIST

1 Information processing device
11 Global trajectory planning unit
12 Local trajectory planning unit
21 Smoothing pre-processing unit
22 Smoothing processing unit
MN Manipulator
101 CPU
102 ROM
103 RAM
106 Input unit
107 Output unit
108 Storage unit
109 Communication unit
110 Drive

1. An information processing device comprising:
a first processing unit that executes a collision avoidance optimization process of searching for a path that collides with an obstacle using N postures corresponding to input trajectories of a machine; and
a second processing unit that sets a target value of each of the N postures to an intermediate position between two postures before and after a current posture and executes the collision avoidance optimization process.

2. The information processing device according to claim 1, wherein
the first processing unit executes the collision avoidance optimization process using positions of the N postures calculated by linear interpolation between a start position and an end position of each of the N postures corresponding to the input trajectories of the machine as target values.

3. The information processing device according to claim 1, wherein
the first processing unit and the second processing unit execute the collision avoidance optimization process in parallel for (N−2) postures excluding a start position and an end position.

4. The information processing device according to claim 1, wherein
the posture is represented by a joint angle of each joint of the machine and a position and a direction of a tooltip of the machine, and
the collision avoidance optimization process is a process of calculating the joint angle of each joint of the machine and the position and the direction of the tooltip of the machine, minimizing a cost function represented by a weighted addition of errors with respect to target values of the joint angle of each joint of the machine and the position and the direction of the tooltip of the machine under constraint that the machine does not collide with an obstacle and an angle limit of the joint angle of each joint is satisfied.

5. The information processing device according to claim 4, wherein
the collision avoidance optimization process is a process of calculating the joint angle of the machine and the position and the direction of the tooltip of the machine, minimizing the cost function represented by a weighted addition further with a penalty function corresponding to an obstacle repulsion zone.

6. The information processing device according to claim 5, wherein
the obstacle repulsion zone is set smaller as the posture is closer to the start position or the end position among the N postures.

7. The information processing device according to claim 4, wherein
the first processing unit sets weighting factors for the joint angle of the machine and the position and the direction of the tooltip of the machine in the cost function to positive values other than zero and executes the collision avoidance optimization process.

8. The information processing device according to claim 4, wherein
the second processing unit sets a weighting factor for the joint angle of the machine to a positive value other than zero, sets weighting factors for the position and direction of the tooltip of the machine in the cost function to zero, and executes the collision avoidance optimization process.

9. The information processing device according to claim 1, wherein
the second processing unit repeatedly executes the collision avoidance optimization process a predetermined number of times, and stops the repetition of the collision avoidance optimization process when the number of repetitions reaches a predetermined number of times or when a difference from a previous processing result is within a predetermined range.

10. An information processing method comprising:
allowing an information processing device to execute:
executing a collision avoidance optimization process of searching for a path that collides with an obstacle using N postures corresponding to input trajectories of a machine; and
setting a target value of each of the N postures to an intermediate position between two postures before and after a current posture and executing the collision avoidance optimization process.

11. A program for causing a computer to execute:
a first process of executing a collision avoidance optimization process of searching for a path that collides with an obstacle using N postures corresponding to input trajectories of a machine; and
a second process of setting a target value of each of the N postures to an intermediate position between two postures before and after a current posture and executing the collision avoidance optimization process.
